(19) United States
(12) Patent Application Publication
(10) Pub. No.: US 2013/0226606 A1
(43) Pub. Date: Aug. 29, 2013

(54) Method, Computer Program and Computer System for Determining a Switch-on Time of a Medical-Technical System Following Failure and Repair

(71) Applicant: Wolfgang Stempfer, Erlangen (DE)

(72) Inventor: Wolfgang Stempfer, Erlangen (DE)

(21) Appl. No.: 13/775,120

(22) Filed: Feb. 23, 2013

(30) Foreign Application Priority Data
Feb. 24, 2012 (DE) DE 102012202821.8

(51) Int. Cl. G06Q 10/00; G06Q 50/22

(52) U.S. Cl. CPC G06Q 10/20; G06Q 50/22
USPC 705/2

(57) ABSTRACT

A computer-implemented method and a computer system for determining a switch-on time of a medical-technical system following failure and repair of a part of the medical-technical system are provided. The computer system determines a supply time of a replacement part and determines a transportation period for the replacement part from a supply point of the replacement part through to the medical-technical system, taking into consideration a chosen transportation device and a traffic situation relevant to the transportation device. The computer system determines a repair duration for replacement and commissioning of the replacement part and calculates the switch-on time as a total of the supply time, the transportation period, and the repair duration.

This application claims the benefit of DE 10 2012 202 821.8, filed on Feb. 24, 2012, which is hereby incorporated by reference.

### BACKGROUND

The present embodiments relate to a computer-implemented method, a computer program, and a computer system for determining a switch-on time of a medical-technical system following failure and repair of a part of the medical-technical system.

Medical-technical systems are complex structures with a large number of components that are subject to wear and/or ageing and may therefore also fail. One example of such systems is X-ray devices in the field of imaging medical technology. In this field, digital imaging methods, in which X-ray radiation penetrating an object positioned in an examining volume is detected in a spatially-resolved manner to generate a correspondingly spatially-resolved X-ray, are used. Using the technology of X-ray computerized tomography, almost any sectional images may be reconstructed through the object being examined, and the sectional images may be displayed for the user.

A computer tomography scanner includes, for example, an X-ray tube, X-ray detectors and a patient table. The X-ray tube and the X-ray detectors are arranged on a gantry that rotates around the patient table or an examination axis running parallel thereto (e.g., the z axis) during the measurement. The patient table may be moved along the examination axis relative to the gantry. The X-ray tube produces an X-ray bundle widened in the shape of a fan in a layer perpendicular to the examination axis. During examinations in the layer, this X-ray bundle penetrates a layer of an object (e.g., a body layer of a patient who is located on the patient table) and strikes the X-ray detectors opposing the X-ray tube. The angle at which the X-ray bundle penetrates the body layer of the patient and, optionally, the position of the patient table relative to the gantry change continuously during imaging using the computer tomography scanner.

The intensity of the X-rays of the bundle that strike the X-ray detectors after penetrating the patient is dependent on the attenuation of the X-rays by the patient. As a function of the intensity of the received X-ray radiation, each detector element of the X-ray detectors generates a voltage signal that is a measure of the global transparency of the body for X-ray radiation from the X-ray tube to the corresponding X-ray detector element. A set of voltage signals of the X-ray detectors, which correspond to attenuation data and have been recorded for a specific position of the X-ray source relative to the patient, may be a projection. A set of projections, which have been recorded at various positions of the gantry during rotation thereof about the patient, may be a scan. The computer tomography scanner records a large number of projections at various positions of the X-ray source relative to the body of the patient to reconstruct an image that corresponds to a two-dimensional cross-section of the body of the patient or a three-dimensional image. The common method for reconstruction of a cross-section from recorded attenuation data is known as the method of filtered back projection.

Due to their importance and high capacity utilization, medical-technical systems (e.g., the computer tomography scanner) should be available at all times. Failure of a component or part disrupts the workflow of the user of a medical-technical system. For improved planning, the user desires fast and accurate information about the length of the repair or the time at which the medical-technical system will be operational again and may be used. Due to the complexity of the service chain existing, service organizations may currently provide only vague and unreliable information. Information about the availability of a replacement part, a probable delivery time of the replacement part to the user and the rough duration of the repair may be provided. This data is not sufficient, however, to provide the user with an accurate time regarding the operational readiness of the medical-technical system as early as during a preliminary clarification of the repair. Owing to existing planning uncertainties, the user includes a safety period in a contingency plans, where patient appointments are unnecessarily postponed. The situation where the medical-technical system is already functional again but there are still no patients scheduled also occurs.

### SUMMARY AND DESCRIPTION

Due to their importance and high capacity utilization, medical-technical systems (e.g., a computer tomography scanner) should be available at all times. Failure of a component or part disrupts the workflow of the user of a medical-technical system. For improved planning, the user desires fast and accurate information about the length of the repair or the time at which the medical-technical system will be operational again and may be used. Due to the complexity of the service chain existing, service organizations may currently provide only vague and unreliable information. Information about the availability of a replacement part, a probable delivery time of the replacement part to the user and the rough duration of the repair may be provided. This data is not sufficient, however, to provide the user with an accurate time regarding the operational readiness of the medical-technical system as early as during a preliminary clarification of the repair. Owing to existing planning uncertainties, the user includes a safety period in a contingency plans, where patient appointments are unnecessarily postponed. The situation where the medical-technical system is already functional again but there are still no patients scheduled also occurs.

The present embodiments may obviate one or more of the drawbacks or limitations in the related art. For example, a method, a computer program and a computer system that enable a more accurate declaration of the time at which a medical-technical system is switched on again following failure of a component are provided.

A computer-implemented method for determining a switch-on time of a medical-technical system following failure and repair of a part of the medical-technical system is provided. A supply time of a replacement part is determined, and a transportation period for the replacement part from a supply point through to the medical-technical system is determined, taking into consideration a chosen transportation device and the traffic situation relevant to the transportation device. A repair duration for the replacement and commissioning of the replacement part is determined, and the switch-on time is calculated as a total of the supply time, the transportation period and the repair duration. The computer-implemented method offers the advantage that, due to improved planning, the switch-on time following a repair may be determined more accurately and significantly more quickly, and therefore, use of the medical-technical system is improved. For example, following failure of a computer tomography scanner, a binding switch-on time may be communicated to a customer within fifteen minutes.

In one embodiment, the information on determining the supply time, the transportation period and the repair duration may originate from at least one database.

In a further embodiment, the traffic situation may include current and predicted dynamic information about the road traffic. The transportation times may be estimated very accurately as a result.

Consideration of the traffic situation in the case of a road transport device (e.g., the transportation device) includes dynamic information from traffic guidance systems and/or traffic monitoring systems. The advantage of this is that existing databases may be accessed.

Determination of the repair time may include information about replacement part-specific repair times from preceding repairs.

In one embodiment, a computer program with a program code for carrying out all method acts of the method if the computer program is executed by a computer (e.g., one or more processors of the computer) is provided. The computer program may be stored on a computer-readable medium (e.g., a non-transitory computer-readable medium).

In one embodiment, a computer system for determining a switch-on time of a medical-technical system following failure and repair of a part of the medical-technical system is provided. The computer system (e.g., one or more processors of the computer system) determines a supply time of a replacement part and a transportation period for the replacement part from a supply point through to the medical-technical system, taking into consideration a chosen transportation device. The computer system also determines the traffic situation relevant to the transportation device, determines a repair duration for the replacement and commissioning of the replacement part, and calculates the switch-on time as a total of the supply time, the transportation period and the repair duration.

In one development, the computer system may include at least one database that keeps ready information on determining the supply time, the transportation period and the repair duration.

In a further embodiment, the computer system may include an interface to at least one traffic guidance system and/or at least one traffic monitoring system that provides current and predicted dynamic information about the road traffic for determining the transportation period.

In one embodiment, a remote service center with a computer system is also provided.

### BRIEF DESCRIPTION OF THE DRAWINGS

FIG. 1 shows a flowchart of one embodiment of a method; and

FIG. 2 shows a block diagram of one embodiment of a remote service center.

### DETAILED DESCRIPTION OF THE DRAWINGS

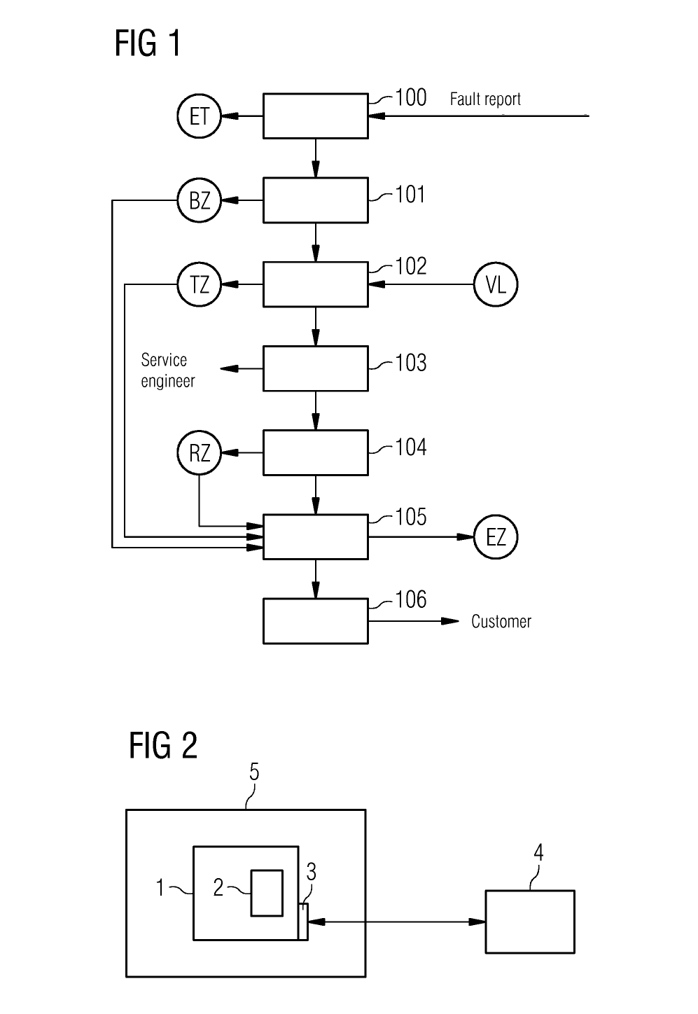

FIG. 1 shows a flowchart of one embodiment of a method for determining a switch-on time of a medical-technical system following failure and repair of a part of the medical-technical system. In act 100, a fault in the medical-technical system is reported by a customer or by remote diagnosis. Using known analysis methods (e.g., using fault detection or pattern detection), a faulty part is determined, and a corresponding replacement part ET identified. In act 101, a supply time BZ of the replacement part ET is determined from a database. This is the time at which the replacement part ET is available (e.g., is ready to be picked up).

In act 102, an appropriate transportation device (e.g., a transportation unit or a transportation system) for picking up and delivering the replacement part ET is determined. For example, the replacement part ET is to be transported to the customer by a taxi or using a company's own fleet vehicle. The transportation period TZ is determined for the chosen transportation device. Values in a database or data from a route planner or destination guidance system are accessed in this connection. In addition, the current and predicted traffic situation VL is also taken into consideration for the supply time BZ. This information comes from existing traffic monitoring systems, traffic control centers, RDS/TMC or commercial congestion information systems. Dynamic information about the road traffic is therefore accessible.

In act 103, the appropriate service engineer is scheduled for the delivery time of the replacement part ET, which corresponds to a total of the supply time BZ and the transportation period TZ, and the replacement part ET is ordered to the customer.

In act 104, the repair duration RZ for the replacement part is determined. Both desired times and times determined from preceding repairs may be taken into consideration in this connection. In act 105, the switch-on time EZ of the medical-technical system is determined as the total of the supply time BZ, the transportation period TZ and the repair duration RZ. In act 106, the switch-on time EZ is communicated to the customer, so the customer may plan future utilization planning of their medical-technical system.

In the case of different transportation devices such as a train or an airplane, information from the control center computers of the transport services and/or transport companies or from the information available on the Internet relating to the current schedule situation is used for determining the transportation time.

FIG. 2 shows one embodiment of a computer system 1 as part of a remote service center 5. With the aid of the remote service center 5, medical-technical systems that are connected to the remote service center 5 in terms of data links are monitored. Services via data line are enabled as a result. A preventative service of medical-technical systems may therefore be provided, for example, instead of a reactive service of medical-technical systems. As a result of pro-active monitoring of the systems, weak points are detected early before the weak points lead to serious faults. The availability of the medical-technical systems increases, and downtimes are reduced. A service may occur via “remote” access to the hardware and software. Remote service centers also assist with repair acceptance and carrying out of the repair in the case of component failure.

Information on the time-related and local availability of all replacement parts of the medical-technical systems is provided in a database 2. The supply time of the replacement part is therefore known in the case of a fault report. The replacement parts may be brought to the medical-technical system to be repaired by a road transport device (e.g., the transportation device) such as a company's own transport fleet or a taxi. The transportation periods from the supply points of the replacement parts through to the customer are provided in the database 2. Alternatively, the transportation period may be determined with a route computer. To be able to also take into consideration the current traffic situation, the computer system 1 has an interface 3 to a traffic control center 4, a traffic guidance center or a congestion information center. The respective current or predicted traffic situation may consequently also be taken into consideration for calculating the transportation period. The accuracy of the prediction of the switch-on time of the medical-technical system to be repaired therefore increases.

The repair duration for the corresponding replacement part is also determined from the database 2. Historic data about repairs that have already been made is taken into consideration in this connection, so the accuracy of the repair duration is continuously improved. Repair duration is determined, for example, as a mean with the aid of statistical methods.

As a result, the total of supply time, transportation period and repair duration is formed, and this produces the switch-on time of the medical-technical system to be repaired. The switch-on time is communicated to the user of the medical-technical system, so that the user may match the patient planning to the switch-on time.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for determining a switch-on time of a medical-technical system following failure and repair of a part of the medical-technical system, the computer-implemented method comprising:
determining a supply time of a replacement part;
determining a transportation period for the replacement part from a supply point of the replacement part through to the medical-technical system, taking into consideration a chosen transportation device and a traffic situation relevant to the transportation device;
determining a repair duration for replacement and commissioning of the replacement part; and
determining the switch-on time as a total of the supply time, the transportation period and the repair duration.

2. The method as claimed in claim 1, wherein information for determining the supply time, the transportation period, and the repair duration originate from at least one database.

3. The method as claimed in claim 1, wherein the traffic situation includes current and predicted dynamic information about road traffic.

4. The method as claimed in claim 3, wherein consideration of the traffic situation in the case of the transportation device includes dynamic information from traffic guidance systems, traffic monitoring systems, or the traffic guidance systems and the traffic monitoring systems.

5. The method as claimed in claim 1, wherein determining the repair duration includes using information about replacement part-specific repair times from preceding repairs.

6. The method as claimed in claim 2, wherein the traffic situation includes current and predicted dynamic information about road traffic.

7. The method as claimed in claim 6, wherein consideration of the traffic situation in the case of the transportation device includes dynamic information from traffic guidance systems, traffic monitoring systems, or the traffic guidance systems and the traffic monitoring systems.

8. The method as claimed in claim 2, wherein determining the repair duration includes information about replacement part-specific repair times from preceding repairs.

9. The method as claimed in claim 3, wherein determining the repair duration includes information about replacement part-specific repair times from preceding repairs.

10. The method as claimed in claim 4, wherein determining the repair duration includes information about replacement part-specific repair times from preceding repairs.

11. In a non-transitory computer-readable storage medium that stores program code executable by one or more processors to determine a switch-on time of a medical-technical system following failure and repair of a part of the medical-technical system, the program code including instructions comprising:
determining a supply time of a replacement part;
determining a transportation period for the replacement part from a supply point of the replacement part through to the medical-technical system, taking into consideration a chosen transportation device and a traffic situation relevant to the transportation device;
determining a repair duration for replacement and commissioning of the replacement part; and
determining the switch-on time as a total of the supply time, the transportation period and the repair duration.

12. A computer system for determining a switch-on time of a medical-technical system following failure and repair of a part of the medical-technical system, the computer system comprising:
a processor configured to:
determine a supply time of a replacement part;
determine a transportation period for the replacement part from a supply point of the replacement part through to the medical-technical system, taking into consideration a chosen transportation device and a traffic situation relevant to the transportation device;
determine a repair duration for replacement and commissioning of the replacement part; and
calculate the switch-on time as a total of the supply time, the transportation period, and the repair duration.

13. The computer system as claimed in claim 12, further comprising at least one database operable to keep ready information for determining the supply time, the transportation period, and the repair duration.

14. The computer system as claimed in claim 12, further comprising an interface to at least one traffic guidance system, at least one traffic monitoring system operable to provide current and predicted dynamic information about the road traffic for determining the transportation period, or a combination thereof.

15. The computer system as claimed in claim 13, further comprising an interface to at least one traffic guidance system, at least one traffic monitoring system operable to provide current and predicted dynamic information about the road traffic for determining the transportation period, or a combination thereof.

16. A remote service center comprising:
a computer system for determining a switch-on time of a medical-technical system following failure and repair of a part of the medical-technical system, the computer system comprising:
a processor configured to:
determine a supply time of a replacement part;
determine a transportation period for the replacement part from a supply point of the replacement part through to the medical-technical system, taking into consideration a chosen transportation device and a traffic situation relevant to the transportation device;
determine a repair duration for replacement and commissioning of the replacement part; and
calculate the switch-on time as a total of the supply time, the transportation period, and the repair duration.

17. The remote service center as claimed in claim 16, further comprising at least one database operable to keep ready information for determining the supply time, the transportation period, and the repair duration.

18. The remote service center as claimed in claim 16, further comprising an interface to at least one traffic guidance system, at least one traffic monitoring system operable to provide current and predicted dynamic information about the road traffic for determining the transportation period, or a combination thereof.
